(19) United States
(12) Patent Application Publication
(10) Pub. No.: US 2012/0198063 A1
(43) Pub. Date: Aug. 2, 2012

(54) VIRTUAL SERVER SYSTEM, AUTONOMOUS CONTROL SERVER THEREOF, AND DATA PROCESSING METHOD AND COMPUTER PROGRAM THEREOF

(75) Inventor: Toshinori Takemura, Tokyo (JP)

(73) Assignee: NEC CORPORATION, Tokyo (JP)

(21) Appl. No.: 13/500,876

(22) PCT Filed: Jul. 7, 2010
(86) PCT No.: PCT/JP2010/004427

§ 371 Date: Apr. 6, 2012

(30) Foreign Application Priority Data
Oct. 9, 2009 (JP) 2009-235332

(51) Int. Cl. G06F 15/173

(52) U.S. Cl. 709/224

(57) ABSTRACT

An autonomous control server (2) connected to a plurality of physical servers (31 to 3m) on which a plurality of virtual servers (311 to 3mn) run through a communication network (1) measures maximum processing performance of each of a plurality of the physical servers (31 to 3m) as a process of a first pass and determines an amount of resources that satisfies an required amount of processing performance of each of a plurality of the virtual servers (311 to 3mn) as a process of a second pass. Therefore, the amount of resources that satisfies the required amount of processing performance of the virtual servers (311 to 3mn) can be allocated to the virtual servers (311 to 3mn). Thereby, a virtual server system which can prevent a capacity shortage of the virtual servers and useless free resources from occurring is provided.

### TECHNICAL FIELD

The present invention relates to a virtual server system in which a plurality of physical servers on which a plurality of virtual servers run are connected to an autonomous control server through a communication network, the autonomous control server thereof, a data processing method thereof, and a computer program thereof.

### BACKGROUND ART

In recent years, a virtual server technique in which a plurality of virtual servers are formed on one physical server by software and a plurality of processes are simultaneously executed by the plurality of virtual servers is realized. According to such a virtual server technique, it is possible to construct a system in which a plurality of virtual servers run at the same time on a plurality of physical servers connected to each other through a communication network.

In such a virtual server system in which a plurality of virtual servers run on a plurality of physical servers, a technique for dynamically measuring processing performance of free resources in a physical server and comparing processing performance of virtual servers running on physical servers whose performance is different from each other is conventionally known.

In a virtual server environment in which a virtual server runs on a plurality of physical servers, a technique for measuring margin of processing power of a plurality of physical servers on the same basis is disclosed (for example, see Patent Document 1).

### RELATED DOCUMENT

### Patent Document

Patent Document 1: Japanese Patent No. 4240062

### DISCLOSURE OF THE INVENTION

Although, for a conventional virtual server system as described above, a method for measuring performance of a physical server in an environment in which servers of different types coexist is described, a specific method for executing a performance measuring program is not specified at all. Therefore, there is a problem that it is difficult to accurately determine processing performance when a virtual server actually runs only by simply executing a benchmark program.

The present invention is made to solve the problem in the conventional technique as described above, and an object of the present invention is to provide a method for estimating processing performance when a virtual server runs, which is difficult to determine only by simply executing a benchmark program.

A virtual server system of the present invention includes a plurality of physical servers on which a plurality of virtual servers run and at least one autonomous control server connected to the plurality of the physical servers through a communication network. The autonomous control server has a performance measurement execution unit which measures maximum processing performance of each of the plurality of the physical servers as a process of a first pass and determines an amount of resources that satisfies a required amount of processing performance of each of the plurality of the virtual servers as a process of a second pass.

An autonomous control server of the present invention is connected to a plurality of physical servers on which a plurality of virtual servers run through a communication network. The autonomous control server includes a performance measurement execution unit which measures maximum processing performance of each of a plurality of the physical servers as a process of a first pass and determines an amount of resources that satisfies a required amount of processing performance of each of a plurality of the virtual servers as a process of a second pass.

A data processing method of the present invention is a data processing method of an autonomous control server connected to a plurality of physical servers on which a plurality of virtual servers run through a communication network. The data processing method includes measuring maximum processing performance of each of a plurality of the physical servers as a process of a first pass and determining an amount of resources that satisfies a required amount of processing performance of each of a plurality of the virtual servers as a process of a second pass.

A computer program of the present invention is a computer program of an autonomous control server connected to a plurality of physical servers on which a plurality of virtual servers run through a communication network. The computer program includes a process of measuring maximum processing performance of each of a plurality of the physical servers as a process of a first pass and a process of determining an amount of resources that satisfies a required amount of processing performance of each of a plurality of the virtual servers as a process of a second pass.

In a virtual server system of the present invention, an autonomous control server connected to a plurality of physical servers on which a plurality of virtual servers run through a communication network measures maximum processing performance of each of a plurality of the physical servers as a process of a first pass and determines an amount of resources that satisfies a required amount of processing performance of each of a plurality of the virtual servers as a process of a second pass. Therefore, the amount of resources that satisfies the required amount of processing performance of the virtual server may be allocated to the virtual server. As a result, it may prevent a capacity shortage of the virtual server and useless free resources from occurring. This is because the processing performance of the virtual server is analyzed by two-stage measurement, so that the allocated amount of resources necessary and sufficient to satisfy the required amount of processing performance of the virtual server is adjusted.

### BRIEF DESCRIPTION OF THE DRAWINGS

The object described above, other objects, features, and advantages are further made clear by the preferred embodiments described below and the following drawings accompanied thereby.

FIG. 1 is a schematic block diagram showing a configuration of a first embodiment of the present invention.

FIG. 2 is a flowchart showing an operation of the first embodiment of the present invention.

FIG. 3 is a schematic diagram showing a data structure of the required amount of resources.

FIG. 4 is a schematic diagram showing a data structure of maximum processing performance of resources.

FIG. 5 is a flowchart showing an operation of the first embodiment of the present invention.

FIG. 6 is a schematic diagram showing a data structure of the allocated amount of resources.

FIG. 7 is a schematic diagram showing a data structure of the used amount of resources and CPU utilization which are measured.

FIG. 8 is a schematic diagram showing a data structure of the modified allocated amount of resources.

FIG. 9 is a schematic diagram showing a data structure of the used amount of resources and CPU utilization which are re-measured.

FIG. 10 is a block diagram showing a configuration of a second embodiment of the present invention.

FIG. 11 is a flowchart showing an operation of the second embodiment of the present invention.

FIG. 12 is a flowchart showing an operation of the second embodiment of the present invention.

### DESCRIPTION OF EMBODIMENTS

### First Embodiment

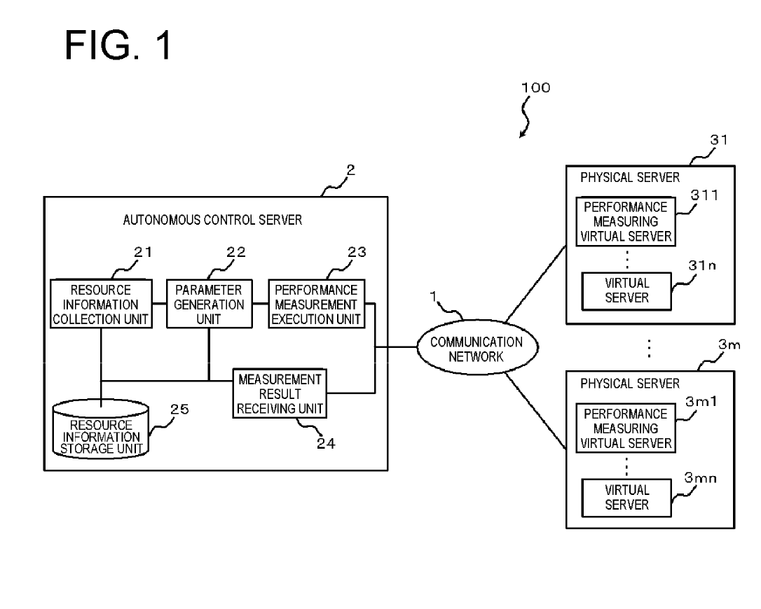

A first embodiment of the present invention will be described below with reference to FIGS. 1 to 9.

As shown in FIG. 1, a virtual server system 100 of the present embodiment has a plurality of physical servers 31 to 3m (m is a positive integer) and an autonomous control server 2 that manages virtual servers running on the physical servers 31 to 3m as hardware.

The autonomous control server 2 and the physical servers 31 to 3m are connected to each other through a communication network 1. Each of the physical servers 31 to 3m is realized by, for example, a computer device in which a Central Processing Unit (CPU) performs various data processing such as operation control of a communication control device according to a computer program which is loaded from a recording medium (magnetic disk, semiconductor memory, optical disk, and the like) and stored in memory such as Random Access Memory (RAM).

Virtual servers 311 to 31n to virtual servers 3m1 to 3mn are logically realized in the physical servers 31 to 3m by installed computer programs. In FIG. 1, reference symbols 311 to 31n are given to the virtual servers running on the physical server 31 and reference symbols 3m1 to 3mn are given to the virtual servers running on the physical server 3m to differentiate them (n is a positive integer).

The autonomous control server 2 is also physically realized by a computer device similar to that of the physical servers 31 to 3m and a resource information collection unit 21, a parameter generation unit 22, a performance measurement execution unit 23, a measurement result receiving unit 24, and a resource information storage unit 25 are logically realized by an installed computer program.

The resource information collection unit 21 receives CPU utilization, memory utilization, an input/output performance value of a recording medium (for example, a ratio of an input/output data transfer speed to a maximum data transfer speed), input/output performance values of a communication control device (transmission speed, used bandwidth, and the like) of each of the physical servers 31 to 3m and the virtual servers 311 to 3mn from each of the physical servers 31 to 3m and the virtual servers 311 to 3mn as resource information.

The parameter generation unit 22 generates a parameter to measure a maximum processing performance of a physical server in a first pass. The parameter generation unit 22 generates a parameter according to a required amount of processing performance of a virtual server in a second pass.

The performance measurement execution unit 23 transmits an instruction to measure performance to performance measuring virtual servers 311 to 3m1 running on the physical servers 31 to 3m and executes a performance measurement process. The measurement result receiving unit 24 receives performance measurement results measured by the performance measuring virtual servers 311 to 3m1 of the physical servers 31 to 3m.

The resource information storage unit 25 stores the performance measurement results received by the measurement result receiving unit 24 as performance information of each resource. Each unit 21 to 25 of the autonomous control server 2 as described above is logically realized by the computer program installed as described above.

Such a computer program is described to cause the autonomous control server 2 to execute various processes such as, for example, a resource information collection process for obtaining CPU utilization of each of the physical servers 31 to 3m and the virtual servers 311 to 3mn from each of the physical servers 31 to 3m and the virtual servers 311 to 3mn as resource information, a parameter generation process for generating a parameter to measure the maximum processing performance of a physical server in the first pass and generating a parameter according to a required amount of processing performance of a virtual server in the second pass, a performance measurement execution process for transmitting an instruction to measure performance to the performance measuring virtual servers 311 to 3m1 running on the physical servers 31 to 3m and executing the performance measurement process, a measurement result receiving process for receiving the performance measurement results measured by the performance measuring virtual servers 311 to 3m1 of the physical servers 31 to 3m, and a resource information storage process for storing the performance measurement results received by the measurement result receiving unit 24 as performance information of each resource.

In the configuration as described above, in the virtual server system 100 of the present embodiment, the processing performance of the virtual servers 311 to 31n, 3m1 to 3mn is analyzed in a two-step measurement, so that an allocated amount of resources necessary and sufficient to satisfy a required amount of processing performance of the virtual servers 311 to 31n, 3m1 to 3mn can be adjusted and the amount of resources that satisfies the required amount can be allocated to the virtual servers 311 to 31n, 3m1 to 3mn. Therefore, it is possible to prevent a capacity shortage and useless free resources from occurring.

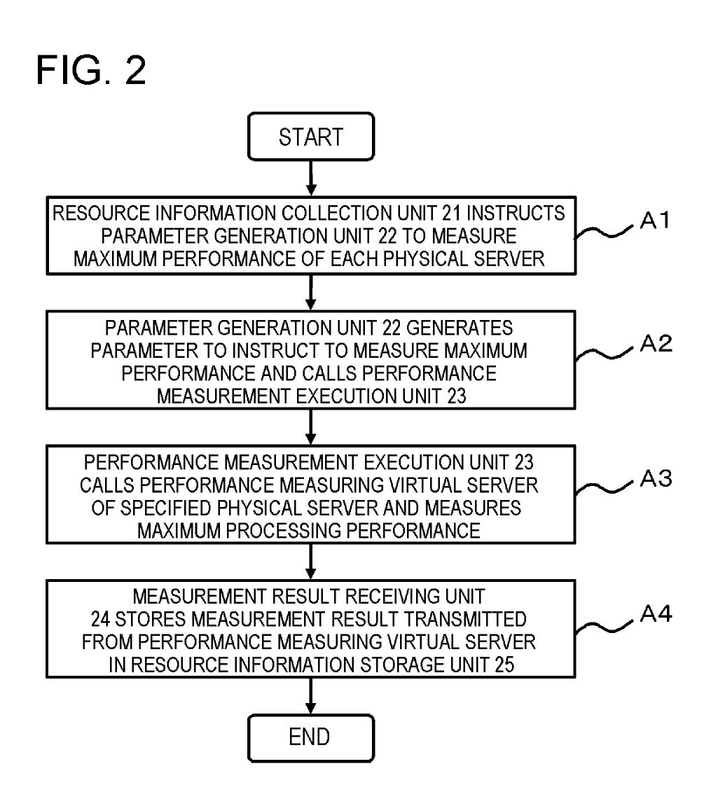

Here, the virtual server system 100 of the first embodiment will be described with reference to FIGS. 2 to 9. FIG. 2 is a flowchart showing a processing procedure of the autonomous control server 2 included in the virtual server system 100 shown in FIG. 1.

In the virtual server system 100 of the first embodiment, an example will be shown in which the processing performance of the virtual servers 311 to 31n, 3m1 to 3mn is measured in two steps including the first pass in which the maximum processing performance of a plurality of physical servers 31 to 3m is measured and the second pass in which the processing performance of the virtual servers 311 to 31n, 3m1 to 3mn according to the required amount is measured.

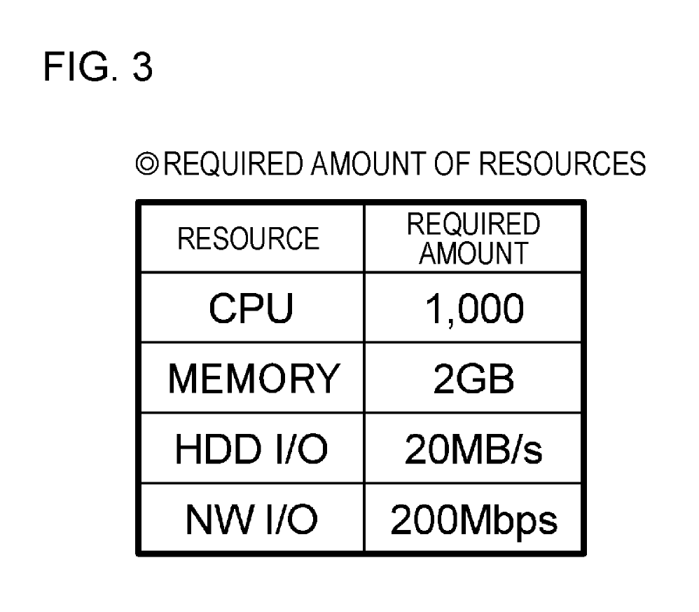

In the autonomous control server 2, the required amount of resources is stored in the resource information storage unit 25 as the processing performance required by the virtual servers 311 to 31n, 3m1 to 3mn. FIG. 3 shows an example of the required amount of resources.

As shown in FIG. 2, in the autonomous control server 2, first, the resource information collection unit 21 instructs the parameter generation unit 22 to measure the maximum performance of the physical servers 31 to 3m (step A1). The parameter generation unit 22 generates a parameter to instruct to measure the maximum performance and calls the performance measurement execution unit 23 (step A2).

Here, regarding the parameter to instruct to measure the maximum performance, a special flag is turned on, the value of the parameter is set to a special value such as −1, or other methods are used to specify the parameter.

The performance measurement execution unit 23 calls the performance measuring virtual servers 311 to 3m1 of the physical servers 31 to 3m and measures the maximum processing performance when the virtual servers 311 to 31n, 3m1 to 3mn run on the plurality of physical servers 31 to 3m (step A3).

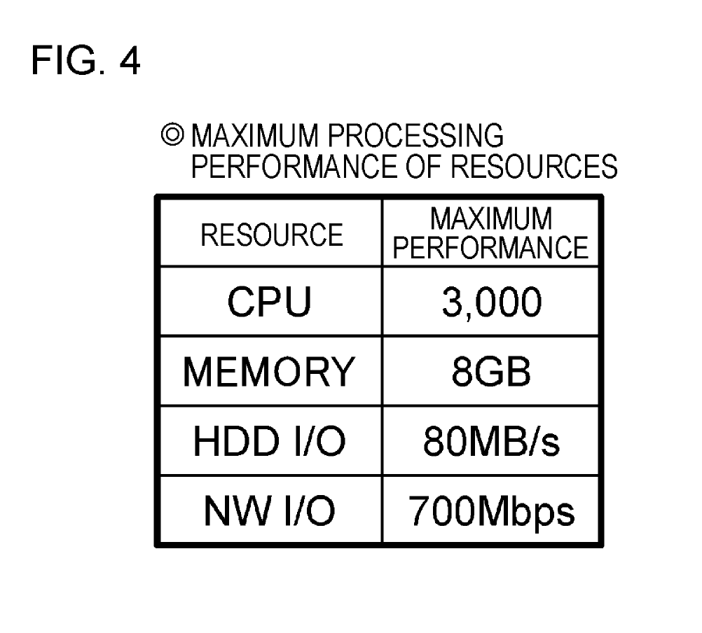

Here, the method of measuring the maximum processing performance is realized by using a conventional technique such as executing a benchmark program or using another dedicated program, and the method is not limited here. FIG. 4 shows an example of a measured maximum processing performance.

Finally, the measurement result receiving unit 24 receives the measurement results transmitted from the performance measuring virtual servers 311 to 3m1 and stores the measurement results in the resource information storage unit 25 (step A4). At this time point, the first pass ends and the measurement of the maximum processing performance of the physical server 31 to 3m is completed.

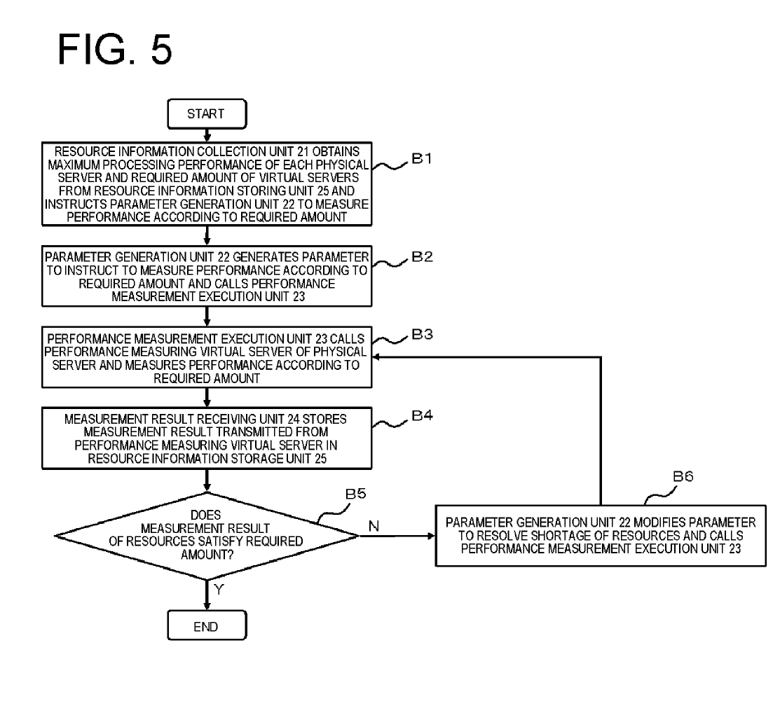

As shown in FIG. 5, measurement of the second pass is performed subsequently. In the autonomous control server 2, first, the resource information collection unit 21 obtains the required amount of resources of the virtual servers 311 to 31n, 3m1 to 3mn (FIG. 3) and the maximum processing performance of the physical servers 31 to 3m from the resource information collection unit 21 and instructs the parameter generation unit 22 to measure performance according to the required amount (step B1).

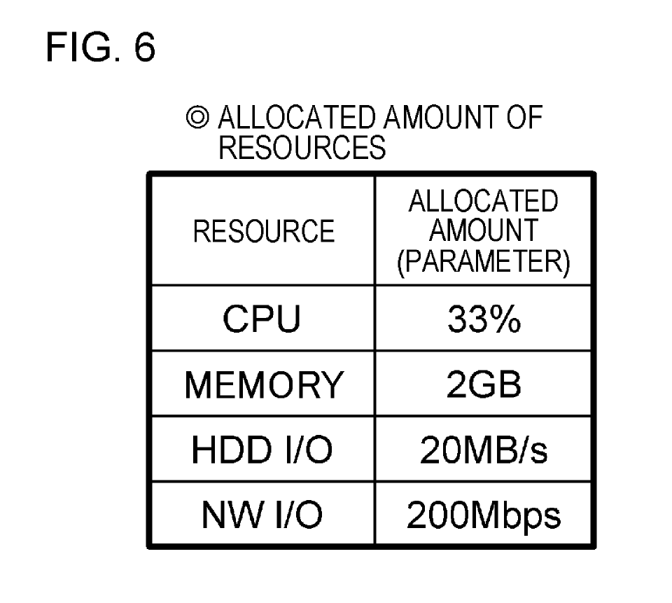

The parameter generation unit 22 generates a parameter (the allocated amount of resources) to instruct to measure the performance according to the required amount and calls the performance measurement execution unit 23 (step B2). FIG. 6 shows an example of the generated allocated amount.

Here, the parameter is generated to allocate ⅓ of the CPU utilization of the physical server. An absolute value of the physical amount of data is specified for the resources other than CPU.

The performance measurement execution unit 23 calls the performance measuring virtual servers 311 to 3m1 of the physical servers 31 to 3m and measures the performance according to the required amount when the virtual servers 311 to 31n, 3m1 to 3mn run on the plurality of physical servers 31 to 3m (step B3).

Here, the method of measuring the performance according to the required amount is realized by using a conventional technique such as executing a benchmark program or using another dedicated program, and the method is not limited here.

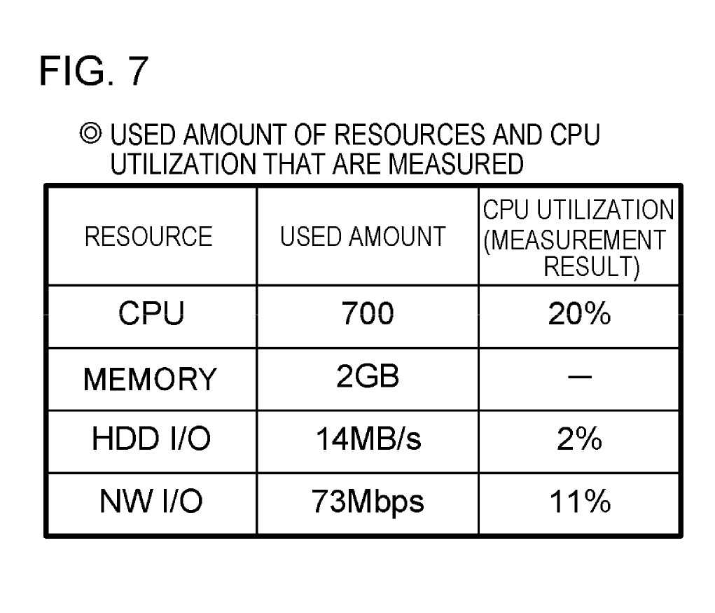

FIG. 7 shows an example of the measurement result of the resources and the CPU utilization of the virtual servers 311 to 31n, 3m1 to 3mn measured based on the required amount (the CPU utilization of I/Os mainly shows the CPU load used to virtualize the I/Os).

The measurement result receiving unit 24 receives the measurement results transmitted from the performance measuring virtual servers 311 to 3m1 and stores the measurement results in the resource information storage unit 25 (step B4). The resource information collection unit 21 determines whether or not the collected measurement results satisfy the required amount (step B5).

If the collected measurement results do not satisfy the required amount, the resource information collection unit 21 obtains the required amount of resources of the virtual servers 311 to 31n, 3m1 to 3mn (FIG. 3), the maximum processing performance of the physical server (hereinafter referred to as the physical server 3i) (FIG. 4), and the measurement result of the resources (FIG. 7) and instructs the parameter generation unit 22 to measure performance according to the required amount (N in step B5).

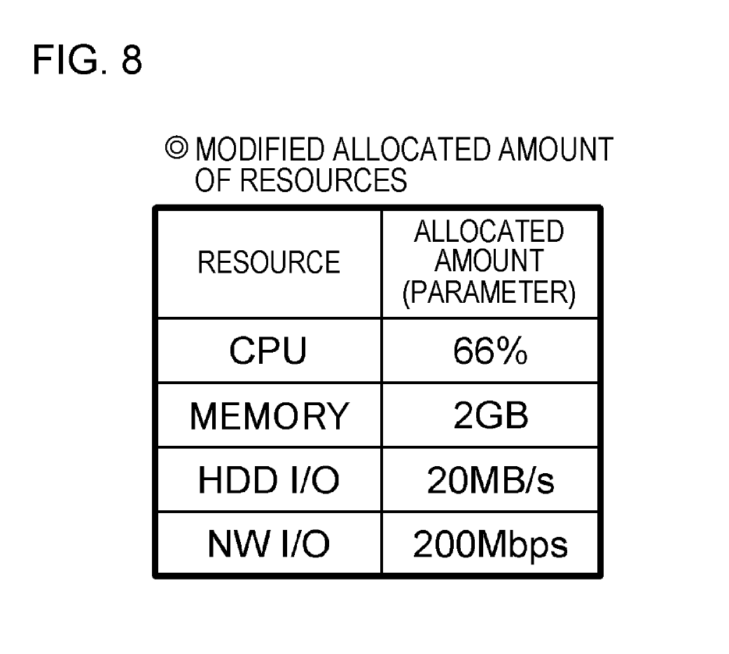

The parameter generation unit 22 determines that the allocated amount of CPU is insufficient from the measurement result of resources, modifies the parameter (allocated amount of resources) so that the CPU utilization of each resource is not insufficient, and calls the performance measurement execution unit 23 (step B6). FIG. 8 shows an example of the modified allocated amount. Here, the parameter is modified to allocate ⅔ of the CPU utilization of the physical server 3i.

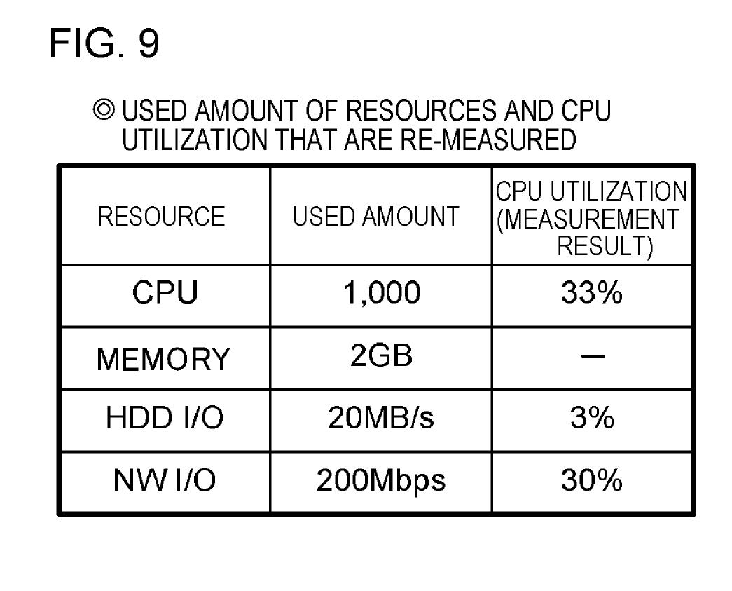

The performance measurement execution unit 23 calls a performance measuring virtual server 3i1 of the physical server 3i (not shown in the drawings) and measures the performance according to the required amount when the virtual servers 3i1 to 3 in run on the physical server 3i (step B3). FIG. 9 shows an example of the measurement result of the resources and the CPU utilization of the virtual servers 3i1 to 3 in measured based on the modified required amount.

The measurement result receiving unit 24 receives the measurement result transmitted from the performance measuring virtual server 3i1 and stores the measurement result in the resource information storage unit 25 (step B4). The resource information collection unit 21 determines whether or not the collected measurement result satisfies the required amount (step B5).

If the collected measurement result satisfies the required amount, the resource information collection unit 21 fixes the modified parameter as the allocated amount of resources with respect to the required amount of resources (Y in step B5). At this time point, the second pass ends and the measurement of the processing performance according to the required amount when the virtual servers 311 to 31n, 3m1 to 3mn run on the plurality of physical servers 31 to 3m is completed.

According to the virtual server system 100 of the present embodiment, it is possible to allocate the amount of resources that satisfies the processing performance of the virtual servers 311 to 31n, 3m1 to 3mn to the virtual servers 311 to 31n, 3m1 to 3mn, so that it is possible to prevent a capacity shortage of the virtual servers 311 to 31n, 3m1 to 3mn and useless free resources from occurring.

### Second Embodiment

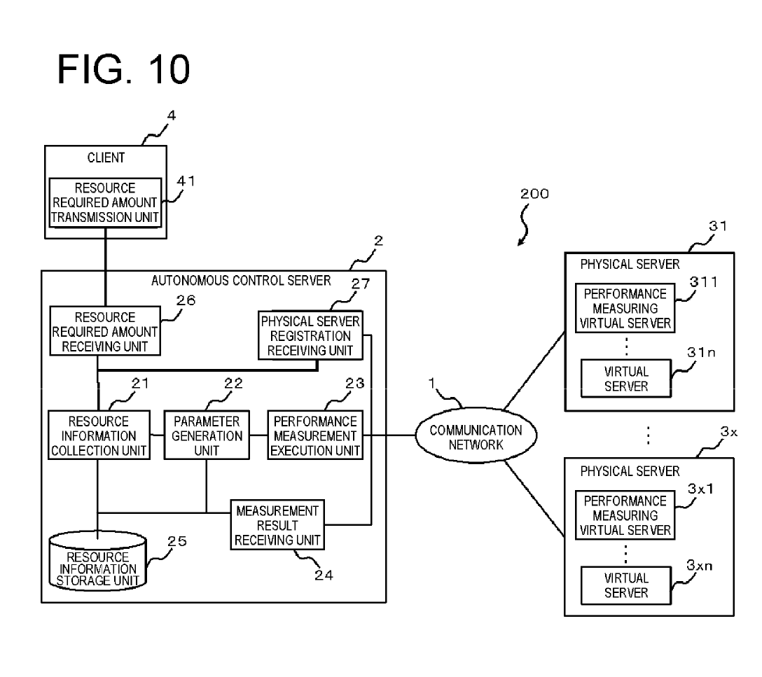

Next, a second embodiment of the present invention will be described in detail with reference to FIGS. 10 to 12.

As shown in FIG. 10, a virtual server system 200 of the second embodiment of the present invention is different from the virtual server system 100 of the first embodiment shown in FIG. 1 in a point that an autonomous control server 2 of the virtual server system 200 has a resource required amount receiving unit 26 and a physical server registration receiving unit 27 in addition to the configuration of the autonomous control server 2 of the first embodiment.

Further, the virtual server system 200 is different from the virtual server system 100 in a point that a new physical server 3x is added in addition to the physical servers 31 to 3m. Further, the virtual server system 200 is different from the virtual server system 100 in a point that a client 4 which transmits the required amount of resources is added with respect to the autonomous control server 2.

The client 4 includes a resource required amount transmission unit 41. The resource required amount transmission unit 41 transmits the required amount of resources specified by an operator, a program, or communication from outside to the resource required amount receiving unit 26 of the autonomous control server 2.

The resource required amount receiving unit 26 of the autonomous control server 2 receives the required amount of resources transmitted from the resource required amount transmission unit 41 of the client 4 and stores the required amount of resources in the resource information storage unit 25 through the resource information collection unit 21.

The physical server 3x starts a performance measuring virtual server 3x1 by a manual operation of an operator or an automatic start-up process of an operating system (OS), so that the physical server 3x registers the physical server 3x in the physical server registration receiving unit 27 of the autonomous control server 2.

The physical server registration receiving unit 27 of the autonomous control server 2 sends an instruction to the resource information collection unit 21 so that the registered physical server 3x performs the process of the first pass to collect the resource information.

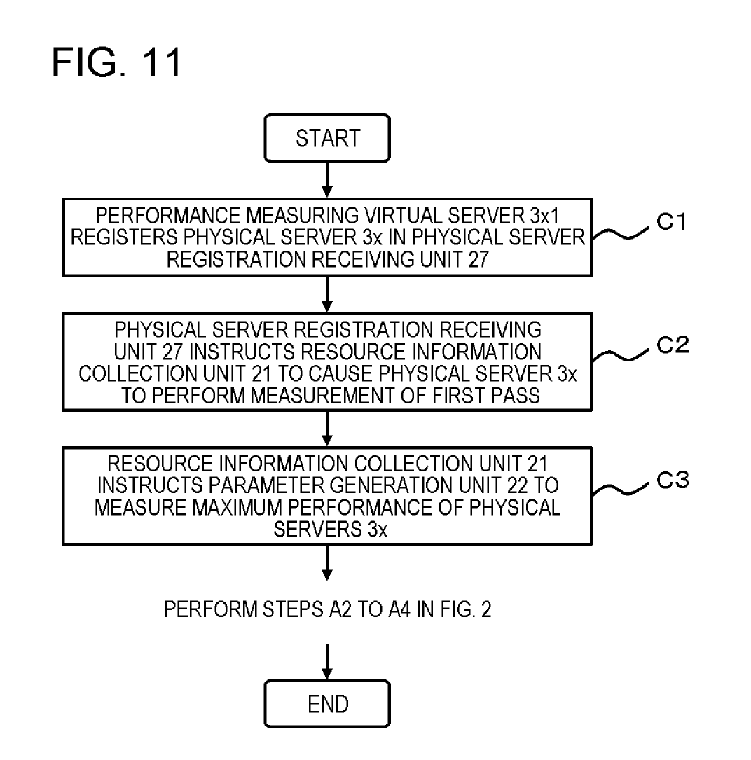

The present embodiment will be described in detail with reference to the drawings. FIG. 11 is a flowchart showing a processing procedure of the second embodiment of the autonomous control server included in the virtual server system 200 shown in FIG. 10.

In the virtual server system 200 of the second embodiment, an example will be shown in which, when a physical server is newly installed, the process of the first pass is performed, and when the required amount of resources is newly specified, the process of the second pass is performed, so that, even when a physical server is added or the required amount of resources is changed, measurement only necessary at that time point can be performed.

The autonomous control server 2 is assumed to have collected the resource information of the physical servers 31 to 3m that have been installed and stores the resource information in the resource information storage unit 25. As shown in FIG. 11, when the physical server 3x is newly added to the physical servers to be managed, the performance measuring virtual server 3x1 of the physical server 3x registers the physical server 3x in the physical server registration receiving unit 27 of the autonomous control server 2 (step C1).

The physical server registration receiving unit 27 instructs the resource information collection unit 21 to cause the physical server 3x to perform the process of the first pass (step C2). The resource information collection unit 21 instructs the parameter generation unit 22 to measure the maximum performance of the physical servers 3x (step C3). The processes thereafter proceed in the same manner as those of step A2 to A4 in FIG. 2.

By the processes described above, when the physical server 3x is added, the process of the first pass is performed and the measurement of the maximum processing performance of the physical server 3x is completed.

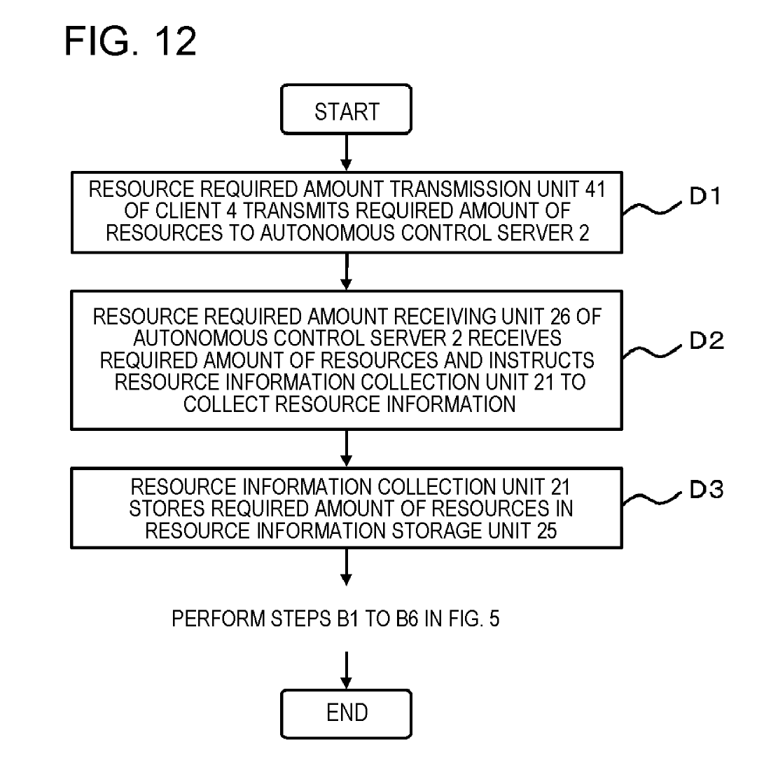

As shown in FIG. 12, when the required amount of resources (FIG. 3) is inputted by an operator, a program, or communication in the client 4, the resource required amount transmission unit 41 transmits the required amount of resources to the resource required amount receiving unit 26 of the autonomous control server 2 (step D1).

The resource required amount receiving unit 26 transfers the required amount of resources (FIG. 3) to the resource information collection unit 21 and instructs the resource information collection unit 21 to collect the resource information (step D2). The resource information collection unit 21 stores the received required amount of resources in the resource information storage unit 25 (step D3).

The processes thereafter proceed in the same manner as those of steps B1 to B6 in FIG. 5. By the processes described above, when the required amount of resources is inputted, the process of the second pass is performed and the measurement of the processing performance according to the required amount when the virtual servers 311 to 31n, 3m1 to 3mn run on the plurality of physical servers 31 to 3m is completed.

According to the virtual server system 200 of the present embodiment, when a physical server is newly installed, the process of the first pass is performed, and when the required amount of resources is newly specified, the process of the second pass is performed, so that, even when a physical server is added or the required amount of resources is changed, measurement only necessary at that time point can be performed.

This application claims a priority based on Japanese Patent Application No. 2009-235332 filed on Oct. 9, 2009 and the entire disclosure thereof is incorporated herein by reference.

1. A virtual server system comprising:
a plurality of physical servers on which a plurality of virtual servers run; and
at least one autonomous control server connected to a plurality of the physical servers through a communication network,
wherein the autonomous control server has a performance measurement execution unit which measures maximum processing performance of each of a plurality of the physical servers as a process of a first pass and determines an amount of resources that satisfies a required amount of processing performance of each of a plurality of the virtual servers as a process of a second pass.

2. The virtual server system according to claim 1, wherein the physical server has a performance measuring virtual server, and
as the process of the first pass, the maximum processing performance is measured by registering information of the physical server on which the performance measuring virtual server runs in the autonomous control server.

3. The virtual server system according to claim 2, wherein the performance measurement execution unit transmits an performance measurement instruction to the performance measuring virtual server running on a plurality of the physical servers to execute a performance measurement process and obtains a performance measurement result measured by the performance measuring virtual server of the physical server.

4. The virtual server system according to claim 3, wherein, as the process of the second pass, the autonomous control server includes a resource information storage unit in which the required amount of resources is registered in advance, so that the amount of resources is determined.

5. The virtual server system according to claim 1, wherein the autonomous control server includes a parameter generation unit which generates a parameter to measure the maximum processing performance of the physical server in the first pass.

6. The virtual server system according to claim 5, wherein the performance measurement execution unit calls the performance measuring virtual server of a plurality of the physical servers and measures the maximum processing performance when each of a plurality of the virtual servers is caused to run on a plurality of the physical servers by using the parameter.

7. The virtual server system according to claim 6, wherein the autonomous control server includes a resource information collection unit which obtains the required amount of resources registered in advance and the maximum processing performance of a plurality of the physical servers and instructs the parameter generation unit to measure performance according to the required amount of resource.

8. The virtual server system according to claim 7, wherein the parameter generation unit generates a parameter according to the required amount of processing performance of the virtual server in the second pass.

9. The virtual server system according to claim 8, wherein the performance measurement execution unit calls the performance measuring virtual server of a plurality of the physical servers and measures performance according to the required amount of resource when a plurality of the virtual servers are caused to run on a plurality of the physical servers by using the parameter.

10. The virtual server system according to claim 9, wherein, when the collected measurement result does not satisfy the required amount of resource, the resource information collection unit obtains a plurality of the required amounts of resources, the maximum processing performance of the physical server, and the measurement result of resources and instructs the parameter generation unit to measure performance according to the required amount of resource.

11. The virtual server system according to claim 10, wherein
the physical server has a CPU,
the parameter generation unit determines that an allocated amount of CPU utilization is insufficient from the measurement result of resources and modifies the parameter so that CPU utilization of each resource is not insufficient, and
the performance measurement execution unit calls the performance measuring virtual server of the physical server and measures again performance according to the required amount when a plurality of the virtual servers are caused to run on the physical server by the modified parameter.

12. An autonomous control server which is connected to a plurality of physical servers on which a plurality of virtual servers run through a communication network, the autonomous control server comprising:
a performance measurement execution unit which measures maximum processing performance of each of a plurality of the physical servers as a process of a first pass and determines an amount of resources that satisfies a required amount of processing performance of each of a plurality of the virtual servers as a process of a second pass.

13. A data processing method of an autonomous control server connected to a plurality of physical servers on which a plurality of virtual servers run through a communication network, the data processing method comprising:
measuring maximum processing performance of each of a plurality of the physical servers as a process of a first pass, and
determining an amount of resources that satisfies a required amount of processing performance of each of a plurality of the virtual servers as a process of a second pass.

14. A computer readable medium storing a computer program of an autonomous control server connected to a plurality of physical servers on which a plurality of virtual servers run through a communication network, the computer program comprising:
a process of measuring maximum processing performance of each of a plurality of the physical servers as a process of a first pass, and
a process of determining an amount of resources that satisfies a required amount of processing performance of each of a plurality of the virtual servers as a process of a second pass.
